(19) United States
(12) Patent Application Publication
(10) Pub. No.: US 2021/0180970 A1
(43) Pub. Date: Jun. 17, 2021

(54) HYBRID VEHICLE AND DRIVING SCHEDULING METHOD THEREFOR

(71) Applicants: HYUNDAI MOTOR COMPANY, Seoul (KR); KIA MOTORS CORPORATION, Seoul (KR)

(72) Inventor: Joon Young Park, Seoul (KR)

(21) Appl. No.: 17/090,622

(22) Filed: Nov. 5, 2020

(30) Foreign Application Priority Data
Dec. 16, 2019 (KR) 10-2019-0168087

(51) Int. Cl. G01C 21/34; G07B 15/06; B60L 58/13

(52) U.S. Cl. CPC G01C 21/3469; G01C 21/3461; B60L 2260/52; G07B 15/06; B60L 58/13; G01C 21/3415

(57) ABSTRACT

A driving scheduling method includes determining a predicted route and exhaust gas emission restriction zones included on the predicted route before driving, when the predicted route includes one or more exhaust gas emission restriction zones, determining whether driving through all the exhaust gas emission restriction zones entirely in an electric vehicle (EV) mode is not possible based on a driving load of the predicted route and initial state of charge (SOC), modifying the predicted route to include a charging route passing through a point at which charging with external power is possible or a detour route detouring at least some of the exhaust gas emission restriction zones when the driving through all the exhaust gas emission restriction zones entirely in the EV mode is not possible, and paying a fee for passing at least some of the exhaust gas emission restriction zones and operating an internal combustion engine in the exhaust gas emission restriction zones for which the fee has been paid when the modification is not possible.

### CROSS REFERENCE TO RELATED APPLICATIONS

This application claims the benefit of Korean Patent Application No. 10-2019-0168087, filed on Dec. 16, 2019, which is hereby incorporated by reference as if fully set forth herein.

### BACKGROUND

### Field

The present disclosure relates to a hybrid vehicle and a driving scheduling method therefor, and more specifically, to a hybrid vehicle and a control method therefor which can perform driving scheduling in consideration of exhaust gas emission restriction zones.

### Discussion of the Related Art

Hybrid electric vehicles generally refer to vehicles using two types of power sources: an engine and an electric motor. Such hybrid electric vehicles have higher fuel efficiency and better power performance than vehicles equipped with only internal combustion engines and are advantageous to reduce exhaust gases, and thus they have recently been increasingly developed.

Such hybrid electric vehicles can operate in two driving modes depending on which powertrain is driven. One of the driving modes is an electric vehicle (EV) mode in which driving is performed using only an electric motor, and the other is a hybrid electric vehicle (HEV) mode in which power is obtained by operating an electric motor and an engine together. Hybrid electric vehicles switch between the two modes according to conditions during driving.

Meanwhile, with the increase in concern for the environment, activities of setting zones where improvement or maintenance of the atmospheric environment is required and regulating emission of exhaust gases in the zones are actively performed. For example, in London, England, an ultra-low emission zone (ULEZ) is set near the city center and only vehicles that satisfy a stricter exhaust gas emission standard are permitted to freely travel from around April 2019. If a vehicle that does not satisfy the standard intends to enter the ULEZ, a predetermined daily ULEZ charge needs to be paid in advance, and when the charge is not paid, a penalty charge tens of times the charge is imposed.

Assuming driving in such a zone, electric vehicles have no problem because they do not emit exhaust gases, whereas hybrid electric vehicles must pay fees or fines when traveling in the HEV mode, which is appropriate, but the hybrid electric vehicles have a problem when traveling in the EV mode. However, it is difficult for an administrative agency which administrates the zone to check battery states of individual vehicles, charging planning of drivers, and whether an engine of a vehicle is driven when the vehicle travels in the zone and to determine whether to impose a fee or a fine. Furthermore, it is difficult for a driver to predict whether the vehicle can travel the entire zone without driving the engine in consideration of a current vehicle state and a driving route, and thus the driver has difficulty determining whether to pre-pay a charge.

### SUMMARY

An object of the present disclosure is to provide a hybrid vehicle which can satisfy requirements of an exhaust gas emission restriction zone or detour the zone when traveling in the zone and a driving scheduling method therefor.

It will be appreciated by persons skilled in the art that the objects that could be achieved with the present disclosure are not limited to what has been particularly described hereinabove and the above and other objects that the present disclosure could achieve will be more clearly understood from the following detailed description.

To achieve these objects and other advantages and in accordance with the purpose of the disclosure, as embodied and broadly described herein, a driving scheduling method for an externally rechargeable plug-in hybrid vehicle according to an embodiment of the present disclosure includes determining a predicted route and exhaust gas emission restriction zones included in the predicted route before driving, when the predicted route includes one or more exhaust gas emission restriction zones, determining whether driving through all the exhaust gas emission restriction zones entirely in an electric vehicle (EV) mode is not possible on the basis of driving load of the predicted route and initial state of charge (SOC), modifying the predicted route such that the predicted route includes a charging route passing through a point at which charging with external power is possible or a detour route detouring at least some of the exhaust gas emission restriction zones when the driving through all the exhaust gas emission restriction zones entirely in the EV mode is not possible, and paying a fee for passing through at least some of the exhaust gas emission restriction zones and operating an internal combustion engine in the exhaust gas emission restriction zones for which the fee has been paid when the modification is not possible.

Furthermore, a plug-in hybrid vehicle which is externally rechargeable according to an embodiment of the present disclosure includes an audio/video/navigation (AVN) system configured to determine a predicted route and exhaust gas emission restriction zones included on the predicted route before driving, a driving determination unit configured to, when the predicted route includes one or more exhaust gas emission restriction zones, determine whether driving through all the exhaust gas emission restriction zones entirely in an electric vehicle (EV) mode is not possible based on driving load of the predicted route and initial state of charge (SOC), and an alternative determination unit configured to modify the predicted route such that the predicted route includes a charging route passing through a point at which charging with external power is possible or a detour route detouring at least some of the exhaust gas emission restriction zones when the driving through all the exhaust gas emission restriction zones entirely in the EV mode is not possible, and to pay a fee for passing through at least some of the exhaust gas emission restriction zones and operate an internal combustion engine in the exhaust gas emission restriction zones for which the fee has been paid when the modification is not possible.

The hybrid vehicle according to at least one embodiment of the present disclosure configured as above can satisfy both environmental standards and convenience by loading a driving control strategy including battery energy management, charging planning, driving mode determination and payment.

It will be appreciated by persons skilled in the art that the effects that can be achieved with the present disclosure are not limited to what has been particularly described hereinabove and other advantages of the present disclosure will be more clearly understood from the following detailed description.

### BRIEF DESCRIPTION OF THE FIGURES

FIG. 1 illustrates an example of a hybrid vehicle configuration to which embodiments of the present disclosure are applicable.

FIG. 2 is a flowchart illustrating an example of a driving scheduling process for a hybrid vehicle according to an embodiment of the present disclosure.

FIG. 3 illustrates an example of classification of classes of roads applied to a hybrid vehicle according to an embodiment of the present disclosure.

FIG. 4 illustrates an example of a driving scheduling form in consideration of a route of the hybrid vehicle according to an embodiment of the present disclosure.

FIG. 5 illustrates an example of an output form of a processing result according to driving scheduling in consideration of an exhaust gas emission restriction zone in the hybrid vehicle according to an embodiment of the present disclosure.

### DETAILED DESCRIPTION

The detailed description of the exemplary embodiments of the present disclosure will be given to enable those skilled in the art to implement and practice the disclosure with reference to the attached drawings. However, the present disclosure can be implemented in various different forms and is not limited to embodiments described herein. In addition, parts that are not related to the description will be omitted for clear description in the drawings, and the same reference numbers will be used throughout this specification to refer to the same or like parts.

Throughout the specification, when it is said that some part “includes” a specific element, this means that the part may further include other elements, not excluding the same, unless mentioned otherwise. In addition, parts denoted by the same reference numeral refer to the same component throughout the specification.

Embodiments of the present disclosure propose a hybrid vehicle having a driving scheduling control function including battery energy management, charging planning, driving mode determination and payment to satisfy both environmental standards and convenience.

Prior to driving scheduling according to embodiments of the present disclosure, the concept of an exhaust gas emission restriction zone applicable to embodiments will be described.

The exhaust gas emission restriction zone may be referred to as an ultra-low emission zone (ULEZ), a zero emission zone (ZEZ), a green zone, or the like and will be referred to as ZEZ in the following description for convenience.

The ZEZ may mean an engine operation inhibition zone where exhaust gas emission is regulated for the purpose of maintaining/improving atmospheric conditions. The ZEZ may be set in advance or may be variably set depending on current/recent situation. Here, a preset zone may correspond to a zone set by regulations or government policy (e.g., an exhaust gas management zone in London or Seoul), a zone requiring exhaust gas reduction due to regional characteristics (e.g., a child protection zone, an indoor parking lot, a residential zone, a park, a drive-through area, a hospital, etc.), or the like. A variably set zone may correspond to an area where current settings can be checked through radio information such as telematics, a pedestrian congested area determined through a vision information acquisition device (ADAS system or the like) included in a vehicle, or the like. Specifically, a variably set zone may correspond to an area where an atmospheric condition has been determined to deteriorate with reference to atmospheric environment information, an area determined to be a pedestrian congested area on the basis of big data using position information of smartphones, and an area where generation of a large quantity of exhaust gases is estimated on the basis of average vehicle speeds and traffic collected through a telematics service or the like.

Furthermore, a zone affected by exhaust gas emission may be set in units of arbitrary administrative district, set as a zone connecting a plurality of coordinates that are boundary points, or set as a specific facility/part thereof or a zone within a predetermined radius from a specific facility/coordinates.

The above-described examples are exemplary and embodiments of the present disclosure are not limited by setting standards, setting ranges and setting periods of such zones.

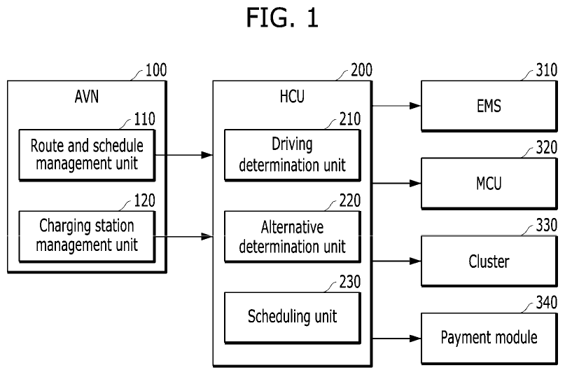

Next, a vehicle configuration for performing driving scheduling control according to an embodiment will be described with reference to FIG. 1. Description will be given on the basis of a plug-in hybrid vehicle (PHEV) in embodiments including FIG. 1 for convenience.

FIG. 1 illustrates an example of a hybrid vehicle configuration to which embodiments of the present disclosure are applicable.

Referring to FIG. 1, a hybrid vehicle according to an embodiment may include an audio/video/navigation (AVN) system 100, a hybrid control unit 200, an engine management system (EMS) 310, a motor control unit (MCU) 320, a cluster 330, and a payment module 340.

The AVN system 100 may include a route and schedule management unit 110 and a charging station information management unit 120. The route and schedule management unit 110 can acquire schedule information of a driver which is personally input by the driver to the AVN system 100 or input through an electronic diary application or the like executed in connection with the AVN system. In addition, the route and schedule management unit 110 can determine a driving route including intermediate stops that the driver must visit on the basis of the acquired schedule information. Here, a destination of the driving route may be explicitly input by the driver or may be estimated on the basis of driving pattern learning. If the stops are not determined, the route and schedule management unit 110 can determine an optimal route from a current position to a destination according to a preset route setting algorithm (fuel-efficiency first, expressway first, shortest distance, shortest time, etc.). Furthermore, the route and schedule management unit 110 may determine an estimated stay time for intermediate (essential) stops on the basis of the schedule information. It is desirable to perform determination of a driving route before driving starts.

In addition, the charging station information management unit 120 can update and manage information about positions of charging stations around routes, waiting situations, charging cost, and the like in real time or periodically.

The hybrid control unit 200 performs overall control of subordinate control units with respect to a powertrain such as the engine management system 310 and the motor control unit 320 and may include a driving determination unit 210, an alternative determination unit 220, and a scheduling unit 230.

The driving determination unit 210 can determine whether driving through all ZEZs present on the driving route in the EV mode is possible through state of charge (SOC) management (e.g., SOC sustaining or charging during driving) in sections other than the ZEZs on the basis of current (initial) SOC.

The alternative determination unit 220 can determine presence or absence of an alternative such as charging with external power or detouring a specific ZEZ for each ZEZ when the driving determination unit 210 determines that driving through all ZEZs entirely in the EV mode is impossible although the driving route includes at least one ZEZ. When an alternative is present, the alternative determination unit 220 provides update information related to the alternative to the driving determination unit 210. In this case, the driving determination unit 210 can re-determine whether driving through all ZEZs entirely in the EV mode is possible on the basis of the update information.

For example, if charging with external power is selected as an alternative, the alternative determination unit 220 can provide updated route information and information on SoC variation in response to a charge amount for stopping at a charging station to the driving determination unit 210. Here, it is desirable that the charging station be located around an essential stop, but the present disclosure is not limited thereto. As another example, in a case where there is no charging station on a driving route, the hybrid vehicle deviates from the driving route by a predetermined range or more, or a time required for charging or an estimated waiting time does not satisfy a schedule, a detour route with respect to at least one ZEZ which does not include essential stops can be set. In such a case, the alternative determination unit 220 can provide information about a detoured ZEZ and the detour route to the driving determination unit 210. Accordingly, the driving determination unit 210 can exclude the detoured ZEZ from the driving route and re-determine whether driving through all ZEZs entirely is possible.

If the alternative determination unit 220 determines that a specific ZEZ corresponds to an essential stop or stopping at a charging station is inappropriate, a fee for passing the specific ZEZ can be paid through the payment module 340. In such a case, the alternative determination unit 220 can provide information about the ZEZ for which the fee has been paid to the driving determination unit 210, and the driving determination unit 210 can regard the ZEZ as a section that is not a ZEZ and re-determine whether driving through all ZEZs entirely is possible.

When the driving determination unit 210 determines that driving through all ZEZs other than ZEZs (i.e., a ZEZ for which a fee has been paid, a detoured ZEZ, and the like) excluded according to determination of the alternative determination unit 220 in the EV mode is possible, the scheduling unit 230 can perform driving mode scheduling (charge depletion, charge sustaining, execution of charging, etc.) for general sections. To this end, the scheduling unit 230 can perform mode allocation per section in consideration of driving load and engine efficiency for general sections. Here, it is desirable to allocate a charge sustaining mode CS to a ZEZ for which a fee has been paid. This is because active use of the engine is against the aim of the ZEZ although it is not possible to apply charge depletion (CD) or the EV mode to the ZEZ.

The engine management system 310 and the motor control unit 320 can respectively control the engine and the motor as determined by the scheduling unit 230. For example, the motor control unit 320 can control the electric motor such that the hybrid vehicle travels only in the EV mode, and the engine management system 310 can operate the engine in a charging section, a charge sustaining section, and the like.

The cluster 330 can output information related to scheduling (e.g., payment history, necessity of stopping at a charging station, and the like) in addition to information related to basic vehicle operation under the control of the hybrid control unit 200.

The payment module 340 executes a function of paying a fee estimated for engine operation in a ZEZ in real time. To this end, the payment module 340 can manage information about payment means (a credit card, a debit card, a rechargeable/pay-later transportation card, transfer account information, etc.) set by a user and may be configured to be able to communicate with a payment server set in advance on the basis of wireless communication. According to an embodiment, the payment module 340 may be embedded in the AVN system 100 or a control unit separate therefrom or may be realized as a separate module.

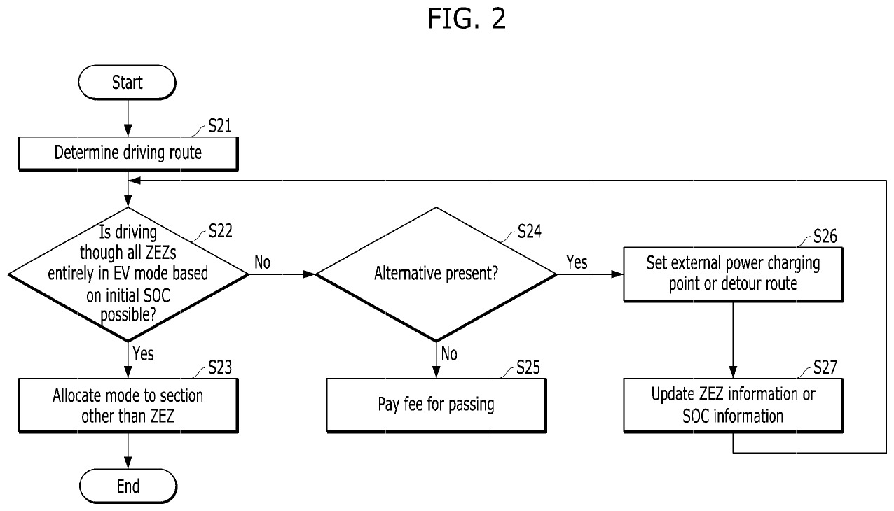

The above-described operations of the vehicle components are arranged as a flowchart of FIG. 2.

FIG. 2 is a flowchart illustrating an example of a driving scheduling process for the hybrid vehicle according to an embodiment of the present disclosure.

Referring to FIG. 2, the AVN system 100 may determine a driving route on the basis of at least one of schedule information of a driver, a trained pattern, and an input destination at S21.

The driving determination unit 210 of the hybrid control unit 200 may determine whether driving through all ZEZs entirely in the EV mode is possible under SoC control during driving on the basis of current (initial) SoC when the determined driving route includes at least one ZEZ at S22. Here, although the driving determination unit 210 determines whether driving through all ZEZs entirely is possible, the driving determination unit 210 may be considered to substantially determine whether driving through all ZEZs entirely is impossible. This is because mode allocation can be performed when the hybrid vehicle can travel in all ZEZs in the EV mode, and if the hybrid vehicle cannot travel in any ZEZ in the EV mode, it is necessary to look for an alternative such as charging with external power or paying a fee for a ZEZ and then excluding the ZEZ from EV mode driving targets until the hybrid vehicle can travel in all ZEZs in the EV mode.

For this, the driving determination unit 210 can detect road states of the route inside ZEZs and determine energy (i.e., ‘ΔSOC_{zezi}’, zezᵢ being an i-th ZEZ) necessary for EV driving for each ZEZ. Here, a road state may include a speed limit, a degree of congestion, a gradient, traffic light state, a crossroad, the shape/number of curved roads, etc. and information about a road state can be acquired from the AVN system 100.

Further, the driving determination unit 210 can ascertain a range of SOC variation (i.e., ‘ΔSOCₛᵢ’, Si being an i-th segment) on a general route (hereinafter referred to as a ‘segment’) before arriving at each ZEZ. The range may be defined by maximum SOC increment and maximum SOC decrement as follows. SOC increment is maximized in the case of driving through all sections (i.e., classes) divided depending on road states in a segment in an HEV charging (CHG or pre-charge) mode, and SOC decrement is maximized in the case of driving through all divided sections in the EV (or charge depletion (CD)) mode. Accordingly, the range of SOC variation ΔSOCₛᵢ can be represented by Mathematical expression 1.

ΣΔSOC@Rdᵢₓ(CD)<=ΔSOCₛᵢ<=ΣΔSOC@Rdᵢₓ(CHG) Mathematical expression 1:

In Mathematical expression 1, Rdᵢₓ represents a divided section according to an x-th road state in Segᵢ.

Further, SOC variation ΣΔSOC@Rdᵢₓ according to CD mode driving in an x-th divided section in Segᵢ can be obtained by Mathematical expression 2.

ΣSOC@Rdᵢₓ(CD)=−∫(average driving load)/(discharging efficiency)dx Mathematical expression 2:

Further, SOC variation according to charge sustaining (CS) mode driving in the x-th divided section in Segᵢ becomes 0 because charge is sustained.

In addition, SOC variation ΣΔSOC@Rdᵢₓ according to charging mode (CHG) driving in the x-th divided section in Segᵢ can be obtained by Mathematical expression 3.

ΔSOC@Rdᵢₓ(CHG)=∫(maximum engine efficiency point power−average driving load)*(charging efficiency)dt (if maximum engine efficiency point>average driving load) or ∫(maximum engine power−average driving load)*(charging efficiency)dt(else) Mathematical expression 3:

When the range of SOC variation ΔSOCₛᵢ (here, Si is an i-th segment) on a general route (hereinafter referred to as a ‘segment’) before arriving at each ZEZ is obtained as described above, it can be determined whether the range of SOC variation ΔSOCₛᵢ satisfies conditions of mathematical expressions 4 and 5 below, that is, whether the hybrid vehicle can travel in the corresponding ZEZi entirely in the EV mode.

SOCᵢ₋₁+ΔSOCₛᵢ<=SOC_{ULmt} Mathematical expression 4:

In Mathematical expression 4, SOCᵢ₋₁ represents initial SOC before Segᵢ starts and SOC_{ULmt} represents a maximum allowable value of SOC. Accordingly, the condition of Mathematical expression 4 represents that SOC variation must not exceed an upper limit for SOC when SOC variation is added to SOC before the i-th segment Segᵢ starts (i.e., charging is performed before a ZEZ).

SOCᵢ=SOCᵢ₋₁+ΔSOCₛᵢ+ΔSOC_{zezi}>=SOC_{LLmt} Mathematical expression 5:

In Mathematical expression 5, ΔSOC_{zezi} represents SOC variation when the hybrid vehicle travels in an i-th ZEZ in the EV mode, and SOC_{LLmt} represents a minimum allowable value of SOC. Accordingly, the condition of Mathematical expression 5 represents that driving through all ZEZs in the EV mode is possible only when the sum of SOC when the i-th ZEZ starts (i.e., SOCᵢ₋₁+SOCᵢ) and SOC consumed while driving through the ZEZ in the EV mode is higher than the minimum allowable value of SOC. Here, ΔSOC_{zezi} can be obtained as −∫(average driving load)/(discharging efficiency)dx.

When the driving determination unit 210 determines that driving through all ZEZs entirely is possible through the above-described method (YES in S22), the scheduling unit 230 can allocate a mode to a section other than ZEZs, that is, each divided section depending on a road state in each segment at S23).

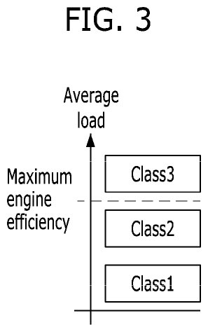

Divided sections depending on road states will be described with reference to FIG. 3.

FIG. 3 illustrates an example of classification of classes of roads applied to the hybrid vehicle according to an embodiment of the present disclosure.

Referring to FIG. 3, driving load depends on road states such as a speed limit, a degree of congestion, gradient, traffic lights, crossroads, and the shapes/number of curved roads. Accordingly, the scheduling unit 230 can classify roads having similar road states, that is, having similar driving loads, as a divided section Rdᵢₓ in each segment and allocate a class per divided section on the basis of criteria as shown in FIG. 3. Specifically, in FIG. 3, class 3 can be allocated when an average driving load is higher than power at an operating point at which the engine has maximum efficiency, and class 2 or class 1 can be allocated depending on driving load when the average driving load is lower than the power. That is, driving load is higher than maximum engine efficiency at class 3 and thus it is desirable to sustain charge because engine efficiency deteriorates when additional charging is performed using engine power, whereas driving load is lower than maximum engine efficiency at class 1 and thus it is efficient to actively use remaining engine power for charging or to cause the hybrid vehicle to travel in the EV (or CD) mode. Accordingly, criteria for mode allocation per class depending on SOC can be defined as shown in Table 1.

TABLE 1

| | SoC | SoC | | SoC | SoC |
|---|---|---|---|---|---|
| Rdᵢₓ | additional | charging | SoC | depletion | additional |
| Class | charging | required | optimal | required | depletion |
| 1 | CHG | CHG | CD | CD | CD |
| 2 | CHG | CHG | CHG | CD | CD |
| 3 | CHG | CS | CS | CS | CD |

In Table 1, CHG represents that a motor generates power using engine power to charge a battery, CD represents charge depletion, and CS represents charge sustaining. Here, the CHG mode may involve control for increasing engine power rather than control of load necessary for driving for power generation.

The criteria of Table 1 are exemplary, and the present disclosure is not limited thereto and the criteria may be modified in various manners.

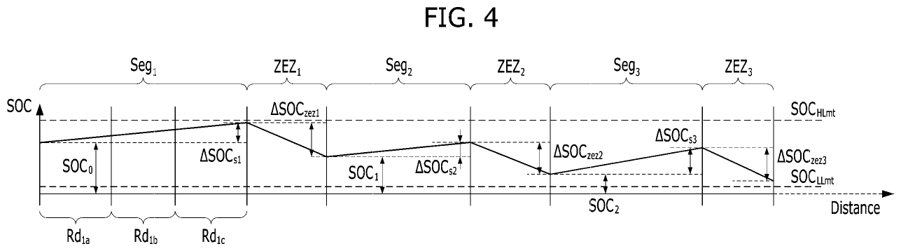

The concepts of the aforementioned terms will be easily understood with reference to FIG. 4.

FIG. 4 illustrates an example of a driving scheduling form in consideration of a route of the hybrid vehicle according to an embodiment of the present disclosure.

Referring to FIG. 4, a total of three ZEZs is present on a driving route and a segment is present in front of each ZEZ.

In segment 1, S000 corresponds to initial SOC of segment 1 (Segᵢ) and Segᵢ is divided into three sections Rd₁ₐ to Rd_{1c} depending on road states. Since SOC increases in all the three divided sections, it can be ascertained that the CHG mode is allocated to each divided section, and SOC that has changed while the hybrid vehicle is traveling in Segᵢ, that is, ΔSOCₛᵢ, has a positive value according to charging. Consequently, SOC when the hybrid vehicle enters the first ZEZ, ZEZ₁, becomes ‘SOC₀+ΔSOCₛ₁’ which does not exceed the maximum allowable value SOC_{ULmt} of SOC. Thereafter, although SOC decreases by ΔSOC_{ZEZ1} according to EV mode driving in ZEZi, SOC is higher than the minimum allowable value SOC_{LLmt} at the end of ZEZi and corresponds to start SOC of Sega, that is, SOC₁.

After Segᵢ and ZEZi, the driving schedule is similar to the aforementioned one and thus redundant description is omitted.

Referring back to FIG. 2, if the driving determination unit 210 determines that driving through all ZEZs entirely in the EV mode is impossible (NO in S22), the alternative determination unit 220 determines an alternative at S24. Types of alternatives and a determination method have been described above with reference to FIG. 2 and thus redundant description is omitted.

When the alternative determination unit 220 determines that there is no alternative (NO in S24), a fee for a ZEZ in which the hybrid vehicle cannot travel in the EV mode may be paid. When there is an alternative (YES in S24), a point at which charging is performed using external power may be included in the route or a detour route may be set at S26.

Furthermore, the alternative determination unit 220 can provide information about a measure at S25 or S26 according to a determination result to the driving determination unit 210. Then, the driving determination unit 210 can update information about a ZEZ when the ZEZ is detoured or a fee for the ZEZ is paid and update charge information when external charging is performed. For example, when external charging is performed within a specific ZEZ in which the hybrid vehicle cannot travel in the EV mode, SOC variation ΔSOC_{zezi} with respect to the ZEZ can be obtained by Mathematical expression 6.

ΔSOC_{zezi}=−∫(average driving load)/(discharging efficiency)dt+ΔSOC_{ExtCharging} Mathematical expression 6:

In Mathematical expression 6, ΔSOC_{ExtCharging} represents SOC variation due to external charging.

In addition, the driving determination unit 210 can set SOC variation ΔSOC_{zezi} of a ZEZ for which a fee has been paid to ‘0’ on the basis of the CS mode allocated to the ZEZ as described above.

Accordingly, the driving determination unit 210 can re-determine whether driving through all ZEZs entirely is possible on the basis of update information of the alternative determination unit 220 at S22.

Meanwhile, information about a scheduling result according to the above-described embodiment may be output in a form that can be recognized by a driver.

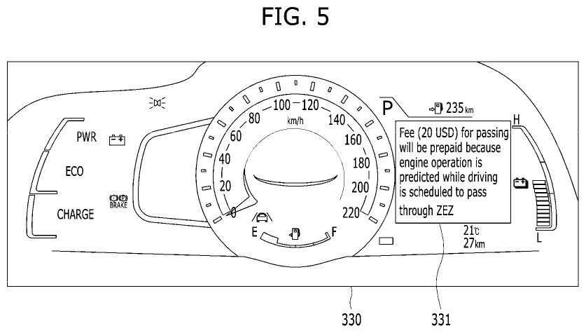

Specifically, the hybrid vehicle according to the embodiment may include display devices such as the cluster 330, a display of the AVN system 100, and a head-up display (HUD). When such a display device receives a signal with respect to a scheduling result from the hybrid control unit 240, corresponding information can be displayed through the display device. This will be described with reference to FIG. 5.

FIG. 5 illustrates an example of an output form of a processing result according to driving scheduling in consideration of an exhaust gas emission restriction zone in the hybrid vehicle according to an embodiment of the present disclosure.

Referring to FIG. 5, in the hybrid vehicle according to the embodiment, information representing that a fee for passing through a ZEZ is paid according to a scheduling result may be output in the form of text in a region 331 that allows text display in the cluster 330.

Such a display form is exemplary and it is obvious to those skilled in the art that text can be substituted with warning light flickering at a fixed position or displayed as an icon.

Furthermore, a display position as well as a display form may also be changed to other positions in the cluster 330, a display of the AVN system 100 or a head unit, a head-up display, and the like.

The above-described present disclosure can be realized as computer-readable code in a medium in which a program is recorded. Computer-readable media include all kinds of recording devices in which data readable by computer systems is stored. Examples of computer-readable media include a hard disk drive (HDD), a solid state drive (SSD), a silicon disk drive (SDD), a ROM, a RAM, a CD-ROM, a magnetic tape, a floppy disk, an optical data storage device, etc.

Therefore, the above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

1. A driving scheduling method for an externally rechargeable plug-in hybrid vehicle, comprising:
determining a predicted route and exhaust gas emission restriction zones included in the predicted route before driving;
when the predicted route includes one or more exhaust gas emission restriction zones, determining whether driving through all the exhaust gas emission restriction zones entirely in an electric vehicle (EV) mode is possible based on a driving load of the predicted route and initial state of charge (SOC);
modifying the predicted route to include a charging route passing through a point at which charging with external power is possible or a detour route detouring at least some of the exhaust gas emission restriction zones when the driving through all the exhaust gas emission restriction zones entirely in the EV mode is not possible; and
paying a fee for passing through at least some of the exhaust gas emission restriction zones, and operating an internal combustion engine in the exhaust gas emission restriction zones for which the fee has been paid when the modification is not possible.

2. The driving scheduling method according to claim 1, wherein when the predicted route includes at least one essential stop, the modifying of the predicted route is performed such that an exhaust gas emission restriction zone including the at least one essential stop from among the one or more exhaust gas emission restriction zones is excluded from targets for which the detour route is set.

3. The driving scheduling method according to claim 2, wherein the modifying of the predicted route comprises setting one of charging stations around the at least one essential stop to the charging route.

4. The driving scheduling method according to claim 1, wherein the predicted route includes one or more exhaust gas emission restriction zones and one or more segments present in front of each of the exhaust gas emission restriction zones,
wherein the determining of whether driving through all the exhaust gas emission restriction zones entirely is not possible comprises, for each segment:
determining a range of SOC variation; and
determining that driving through all the exhaust gas emission restriction zones entirely is possible when the range of SOC variation satisfies a first condition with respect to an upper limit for SOC and a second condition with respect to a lower limit for SOC.

5. The driving scheduling method according to claim 4, wherein the first condition is satisfied when a sum of the range of SOC variation and SOC at the beginning of a corresponding segment does not exceed the upper limit for SOC, and the second condition is satisfied when a value obtained by applying SOC depleted during driving in an exhaust gas emission restriction zone following a corresponding segment in the EV mode to SOC when arriving at the exhaust gas emission restriction zone is equal to or higher than the lower limit for SOC.

6. The driving scheduling method according to claim 4, further comprising, when the driving through all the exhaust gas emission restriction zones is possible, for each segment:
setting at least one divided section depending on a road state; and
allocating a driving mode to each of the at least one divided section.

7. The driving scheduling method according to claim 6, wherein the driving mode includes at least one of a charge sustaining (CS) mode, a charge depletion (CD) mode and a charging mode (CHG) using engine power during driving.

8. The driving scheduling method according to claim 6, wherein the allocating of a driving mode is performed in consideration of average driving load depending on the road state.

9. The driving scheduling method according to claim 1, wherein the driving of an internal combustion engine in the exhaust gas emission restriction zone for which the fee has been paid comprises driving in the charging sustaining (CS) mode.

10. A non-transitory computer-readable recording medium storing a program for executing the driving scheduling method for a plug-in hybrid vehicle according to claim 1.

11. A plug-in hybrid vehicle which is externally rechargeable, the plug-in hybrid vehicle comprising:
an audio/video/navigation (AVN) system configured to determine a predicted route and exhaust gas emission restriction zones included on the predicted route before driving;
a driving determination unit configured to, when the predicted route includes one or more exhaust gas emission restriction zones, determine whether driving through all the exhaust gas emission restriction zones entirely in an electric vehicle (EV) mode is possible based on a driving load of the predicted route and initial state of charge (SOC); and
an alternative determination unit configured to modify the predicted route to include a charging route passing through a point at which charging with external power is possible or a detour route detouring at least some of the exhaust gas emission restriction zones when the driving through all the exhaust gas emission restriction zones entirely in the EV mode is not possible and to pay a fee for passing through at least some of the exhaust gas emission restriction zones and operate an internal combustion engine in the exhaust gas emission restriction zones for which the fee has been paid when the modification is not possible.

12. The plug-in hybrid vehicle according to claim 10, wherein, when the predicted route includes at least one essential stop, the alternative determination unit excludes an exhaust gas emission restriction zone including the at least one essential stop from among the one or more exhaust gas emission restriction zones from targets for which the detour route is set.

13. The plug-in hybrid vehicle according to claim 12, wherein the alternative determination unit sets one of charging stations around the at least one essential stop to the charging route.

14. The plug-in hybrid vehicle according to claim 11, wherein the predicted route includes one or more exhaust gas emission restriction zones and one or more segments present in front of each of the exhaust gas emission restriction zones,
wherein the driving determination unit determines a range of SOC variation and determines that driving through all the exhaust gas emission restriction zones entirely is possible when the range of SOC variation satisfies a first condition with respect to an upper limit for SOC and a second condition with respect to a lower limit for SOC for each segment.

15. The plug-in hybrid vehicle according to claim 14, wherein the first condition is satisfied when a sum of the range of SOC variation and SOC at the beginning of a corresponding segment does not exceed the upper limit for SOC, and the second condition is satisfied when a value obtained by applying SOC depleted during driving in an exhaust gas emission restriction zone following a corresponding segment in the EV mode to SOC when arriving at the exhaust gas emission restriction zone is equal to or higher than the lower limit for SOC.

16. The plug-in hybrid vehicle according to claim 14, further comprising a scheduling unit configured to set at least one divided section depending on a road state and to allocate a driving mode to each of the at least one divided section for each segment when the driving through all the exhaust gas emission restriction zones entirely is possible.

17. The plug-in hybrid vehicle according to claim 16, wherein the driving mode includes at least one of a charge sustaining (CS) mode, a charge depletion (CD) mode and a charging mode (CHG) using engine power during driving.

18. The plug-in hybrid vehicle according to claim 16, wherein the scheduling unit allocates a driving mode in consideration of average driving load depending on the road state.

19. The driving scheduling method according to claim 17, wherein the scheduling unit allocates the charging sustaining (CS) mode to the exhaust gas emission restriction zone for which the fee has been paid.
